(19) United States
(12) Patent Application Publication
(10) Pub. No.: US 2013/0324450 A1
(43) Pub. Date: Dec. 5, 2013

(54) CONSUMER PRODUCTS CONTAINING PRO-FRAGRANCES

(71) Applicants: Daniel Reichlin, Geneva (CH); Eric Frerot, Geneva (CH); Philippe Laurent Schneider, Geneva (CH)

(72) Inventors: Daniel Reichlin, Geneva (CH); Eric Frerot, Geneva (CH); Philippe Laurent Schneider, Geneva (CH)

(73) Assignee: FIRMENICH SA, Geneva 8 (CH)

(21) Appl. No.: 14/000,341

(22) PCT Filed: Feb. 20, 2012
(86) PCT No.: PCT/EP12/52844

§ 371 Date: Aug. 19, 2013

(30) Foreign Application Priority Data
Feb. 21, 2011 (IB) PCT/IB2011/050705

(51) Int. Cl. C11D 3/50

(52) U.S. Cl. CPC C11D 3/50
USPC 510/103

(57) ABSTRACT

The invention relates to novel liquid compositions, comprising: a) a liquid base intended for the treatment of surfaces, in particular fabrics or hard surfaces; b) at least one sulfur-containing compound of formula wherein R¹ and R² represent, separately and independently of each other, a hydrogen atom, a halogen atom, preferably chlorine, a C₁-C₄ linear or branched alkyl group, an amino group or a benzylamino group; or, alternatively, R¹ and R² are taken together to represent a phenyl or pyridine ring, possibly substituted with one to four C₁-C₄ linear or branched alkyl or alkenyl groups and/or one to two halogen atoms, preferably chlorine atoms; and R³ represents a hydrogen atom, an alkali metal atom, in particular Na or k, a phenyl or benzyl group possibly substituted with one or two halogen atoms and/or one or two methyl, trifluoromethyl, methoxy or amino groups, an amine group, or a C₁-C₈ unsaturated, linear, branched or cyclic hydrocarbon group possibly substituted with one or two nitrogen, oxygen or halogen atoms; c) at least one sulfur-containing pro-fragrance compound; and d) one or more perfuming co-ingredients; and wherein the composition has a pH comprised between 1 and 8. The compositions can be advantageously used in methods of treatment of fabric and household surfaces, to impart thereto a fresh, odor stable and long-lasting fragrance. They also show a stable out of the bottle odor, without any off-odor notes, independently of the duration of storage of the bottled liquid products.

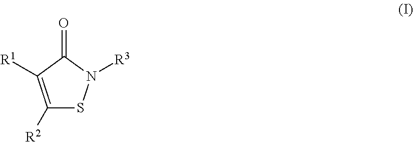

### TECHNICAL FIELD

The present invention relates to perfumery and application of perfuming ingredients in traditionally perfumed consumer products. More particularly, it concerns compositions comprising a combination of ingredients from four different classes and which are capable of imparting a long-lasting odor and better freshness to surfaces such as textiles or hard surfaces, as well as having improved odor stability out of the bottle and after prolonged storage.

### BACKGROUND

Consumers want products that leave a clean and long-lasting freshness odor impression on their textiles and other surfaces treated with cleaning or softening products. Several technologies have been used in the past to achieve this effect, in particular fragrances have been encapsulated prior to incorporation in the treating product, or the experts have resorted to the use of so-called pro-fragrances, i.e. molecules that typically do not themselves impart an odor, but which are capable of releasing an odorant over a certain period of time under use conditions.

As a result, the consumer's perception and preference of the cleaning product can be dictated by the odor that it exhales upon opening of the bottle and by the residual odor that such a product is capable of imparting to the treated surfaces.

Amongst the prior known solutions to prolong the freshness and cleanliness effect of textiles treated with detergents and/or fabric softeners containing pro-fragrances, one can cite in particular the compounds and compositions that are described for example in U.S. Pat. No. 7,723,286 or WO 2008/154765. These prior art documents describe compounds which are capable of releasing one or more ingredients imparting an odor to fabrics or other treated surfaces, the latter having been subjected to the action of a consumer product comprising such compounds.

The present invention brings a new and advantageous contribution to this field by providing products or compositions, namely fabric softeners and all-purpose cleaners, wherein the compounds described in the above-cited prior art documents are combined with particular agents capable of stabilizing the odor impact of the product and to improve its effectiveness to impart a long-lasting, clean and fresh odor to the fabrics or other surfaces treated with such products.

### DESCRIPTION OF THE INVENTION

The object of the present invention is therefore a liquid composition, and more particularly a liquid fabric softener or all-purpose cleaner, comprising:
a) a liquid base intended for the treatment of surfaces, in particular fabrics or hard surfaces;
b) at least one sulfur-containing compound of formula

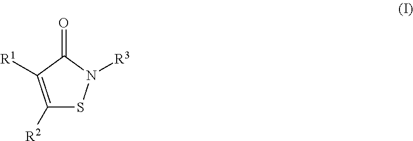

wherein R¹ and R² represent, separately and independently of each other, a hydrogen atom, a halogen atom, preferably chlorine, a C₁-C₄ linear or branched alkyl group, an amino group or a benzylamino group; or, alternatively, R¹ and R² are taken together to represent a phenyl or pyridine ring, possibly substituted with one to four C₁-C₄ linear or branched alkyl or alkenyl groups and/or one to two halogen atoms, preferably chlorine atoms; and
R³ represents a hydrogen atom, an alkali metal atom, in particular Na or k, a phenyl or benzyl group possibly substituted with one or two halogen atoms and/or one or two methyl, trifluoromethyl, methoxy or amino groups, an amine group, or a C₁-C₈ unsaturated, linear, branched or cyclic hydrocarbon group possibly substituted with one or two nitrogen, oxygen or halogen atoms;
c) at least one sulfur-containing pro-fragrance compound; and
d) one or more perfuming co-ingredients;
   and wherein the composition has a pH comprised between 1 and 8.

According to specific embodiments of the compositions, the latter consist of a mixture of the above-cited components. By a composition “consisting of” it is understood here a composition which contains essentially the four components cited above, together with insignificant, i.e. not more than 2% by weight, and preferably not more than 1% weight, relative to the weight of the composition, of any other components and wherein the latter do not significantly affect the cleaning, softening and/or perfuming properties and activity of the composition.

As cited above, the compositions of the invention are characterized by a pH of 1 or more. Said pH is not above 8, liquid compositions having a pH below 6 being more preferred for the purposes of the invention.

In all embodiments of the invention, the component a) as defined above is typically a liquid base comprising ingredients that are common in the home care consumer products, in particular fabric detergents or softeners and all-purpose cleaners.

The main functional components of such liquid bases are surfactants and/or softener components capable of cleaning and/or softening fabrics and/or textiles of varied nature, such as clothes, curtain fabrics, carpet and furniture fabrics, etc, or other home surfaces, and typically used in a large amount of water or water-based solvents. These are therefore formulations wherein the amount of water is typically comprised between 50 and 99% by weight of the liquid base. The term “base” is used here in the sense of the main component of the composition according to the invention and not in the sense of a liquid having a basic pH.

A more detailed description of such fabric cleaning and/or softening bases is not warranted here, many descriptions of current liquid bases can be found in the cleaner/fabric softener's patent and other pertinent literature, such as for example the textbook of Louis Ho Tan Tai, “Détergents et Produits de Soins Corporels, Chapters 1 to 7 in particular, Dunod, Paris, 1999, or any other similar and/or more recent textbooks pertaining to the art of liquid softener and all-purpose cleaners formulations. A recent patent publication, WO 2010/105873, is also cited by way of example, in as much as it describes typical current ingredients, other than perfumes, of such liquid products, particularly in pages 9 to 21. Of course, many other examples of liquid cleaner and/or fabric softener bases can be found in the literature. Any such liquid base, namely liquid fabric cleaner or conditioner and/or all-purpose cleaner, can be used in the here-described compositions.

Component a) typically represents at least 90% by weight, and may represent up to 99.95% by weight, of the total weight of the composition according to the invention, typically from 95% to 99.9% of the total weight of the invention's compositions, and more preferably from 98% to 99.8% of the total weight of the product.

Component b) of the compositions according to the invention is a sulfur-containing compound of formula (I) as defined above. Preferred compounds of formula (I) in all the compositions of the invention are compounds wherein R¹ and R² represent, separately and independently of each other, a hydrogen atom, a chlorine atom or a methyl group or, alternatively, R¹ and R² are taken together to represent a phenyl ring, and R³ represents a hydrogen atom or a methyl group.

According to specific combinations of the components b) with any one of the possible components a), c) and d) according to the invention, b) is preferably selected from the group of isothiazolones consisting of 1,2-benzisothiazol-3(2H)-one, 4- or 5-chloro-2-methylisothiazol-3(2H)-one or 2-methylisothiazol-3(2H)-one. Even more preferably, component b) is 5-chloro-2-methylisothiazol-3(2H)-one or 1,2-benzisothiazol-3(2H)-one, and most preferably 1,2-benzisothiazol-3(2H)-one.

Component b) is present in the compositions of the invention at a weight concentration of 0.0001% or more, relative to the total weight of the composition. It can form up to 5% of the total weight of the composition. According to more preferred embodiments of the invention, the concentration of sulfur-containing compound of formula (I) in the compositions is comprised between 0.001 and 3% of the total weight, with concentrations of between 0.005 and 0.1% weight of component b), of the total weight of the composition, being more preferred embodiments of the liquid compositions of the invention.

The compositions of the invention contain a pro-fragrance as component c) thereof. By a “pro-fragrance” it is understood here a component that is one or more of the compounds described in the prior art cited above, i.e. U.S. Pat. No. 7,723,286 and/or WO 2008/154765. Such compounds, although non-odorant as such, have the ability to release fragrant molecules under use/application conditions, i.e. upon application of the compositions according to the invention. The compositions may contain one or several such compounds, the latter allowing the controlled release of a variety of different odor imparting substances, which may be an advantage over slowly releasing just one fragrance ingredient as will happen if just one pro-fragrance compound is used.

According to specific embodiments of any one of the compositions of the invention, the pro-fragrance is at least one compound of formula

Y—S-G-Q (II)

in which:
Y represents a radical selected amongst the group of radicals (Y-1) to (Y-7) shown here below, in any one of their possible isomeric forms, the wavy lines representing the location of the Y—S bond and the dotted lines representing the location of a single or double bond

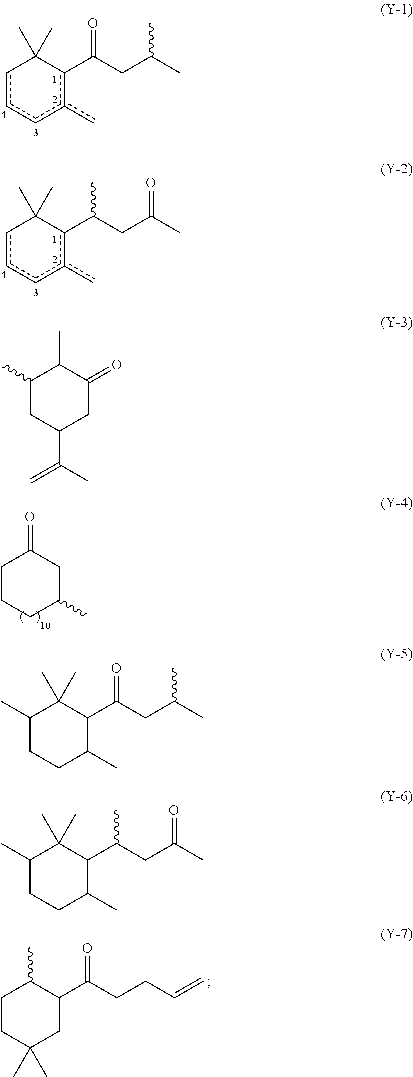

G represents a divalent or trivalent radical derived from a linear or branched alkyl or alkenyl radical having from 2 to 15 carbon atoms, possibly substituted with one or more groups selected from the group consisting of —OR⁴, —NR⁴₂, —COOR⁴ and R⁴ groups, in which R⁴ represents a hydrogen atom or a C₁ to C₆ alkyl or alkenyl group; and
Q represents a hydrogen atom, a —S—Y group or a NR⁵—Y group, Y being defined as above and R⁵ representing a hydrogen atom or a methyl group.

According to more specific embodiments of component c), the pro-fragrance chemical is a formula (II) compound wherein Y is defined as above, G is a divalent radical derived from a linear or branched alkyl or alkenyl radical having from 2 to 15 carbon atoms, possibly substituted by a —COOR⁴ group, wherein R⁴ is defined as above. More preferably, G is a divalent radical derived from a linear alkyl radical having from 8 to 15 carbon atoms or a —CH₂CH(COOR⁴) group, wherein R⁴ is a hydrogen atom or a methyl or ethyl group.

According to more preferred embodiments of the invention, wherein components a), c) and d) are generally defined as above, the pro-fragrance compound is a compound of formula (II) wherein Y is any one of the Y-1, Y-2 or Y-3 groups represented above, and G and Q are defined in any one of the above-described embodiments.

The compositions of the invention wherein the pro-fragrance component is selected from the group consisting of methyl or ethyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate, methyl or ethyl 2-(4-oxo-4-(2,6,6-trimethylcyclohex-2-en-1-yl)butan-2-ylamino)-3-(4-oxo-4-(2,6,6-trimethylcyclohex-2-en-1-yl)butan-2-ylthio)propanate, methyl or ethyl 2-(2-oxo-4-(2,6,6-trimethylcyclohex-1-en-1-yl)butan-4-ylamino)-3-(2-oxo-4-(2,6,6-trimethylcyclohex-1-en-1-yl)butan-4-ylthio)propanate, methyl or ethyl 2-(2-oxo-4-(2,6,6-trimethylcyclohex-2-en-1-yl)butan-4-ylamino)-3-(2-oxo-4-(2,6,6-trimethylcyclohex-2-en-1-yl)butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 4-(dodec ylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-dodecylsulfanyl-5-methyl-heptan-4-one, 2-cyclohexyl-1-dodecylsulfanyl-hept-6-en-3-one and 3-(dodecylthio)-5-isopropenyl-2-methylcyclohexanone, all other three components a), b) and d) being defined as previously, according to anyone of their possible embodiments cited, have proved most advantageous for the purposes of the invention. Amongst these, 3-(dodecylthio)-1-(2,6,6-trimethylcyclohex-3-en-1-yl)-1-butanone, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone and 3-(dodecylthio)-5-isopropenyl-2-methylcyclohexanone, were most appreciated by the perfumers for the odor quality and impact obtained on the fabrics treated with the compositions of the invention.

Compositions comprising 3-(dodecylthio)-1-(2,6,6-trimethylcyclohex-3-en-1-yl)-1-butanone as the pro-fragrance component proved to be most advantageous.

The concentrations in which component c) is used in the compositions of the invention are of at least 0.0001% by weight, of the weight of the composition.

The component d) of the composition is a perfuming ingredient, the nature and type of which do not warrant a more detailed description here, which in any case would not be exhaustive, the skilled person being able to select them on the basis of its general knowledge and according to intended use or application and the desired organoleptic effect. In general terms, these perfuming co-ingredients belong to chemical classes as varied as alcohols, aldehydes, ketones, esters, ethers, acetates, nitriles, terpene hydrocarbons, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, such as H. Surburg, J. Panten, Common Fragrance and Flavor Materials—Preparation, Properties and Uses, 5th Ed., Wiley-VCH, Weinheim, 2006, as well as in the abundant patent literature in the field of perfumery. It is also understood that said co-ingredients may also be compounds known to release in a controlled manner various types of perfuming compounds.

According to any embodiment of the liquid compositions of the invention, the latter contain at least 0.01% of at least one of such perfuming co-ingredients, and up to 3% weight, relative to the total weight of the composition. Preferred concentrations of the perfuming co-ingredients are comprised between 0.1 and 2 weight % and more preferably between 0.2 and 1.8 weight %, of the total weight of the liquid composition.

We have established that the combination of components entering into the compositions here-described provides surprisingly improved fabric treatment products, over prior known products of similar type, their odor quality out of the bottle being remarkably more pleasant and stable, without any off-odor formation, and the odor of surfaces, in particular fabrics, treated with such compositions being perceived as longer lasting and more fresh.

The different ingredients of the compositions, in particular components b), c) and d), may be used in a pure form or in solution in solvents of current use in perfumery, namely alcohols such as ethanol, propanol, isopropanol, butanol, propanediol, octanediol, phenoxyethanol, dipropylene glycol or in water, as well as in mixtures thereof.

The compositions of the invention are useful in methods of treatment of various surfaces, in particular fabrics and textiles. In such methods of use, they shall be applied as is current in washing and other fabric treating methods, both manually and in machine washing procedures, to produce their perfuming and long-lasting odor effect that is desired to impart to such fabrics.

Such use methods are also the object of the invention.

The invention is now described in further detail by way of the following examples, wherein the abbreviations have the usual meaning in the art. The components of formula (I) used are commercially available, either in pure form or sometimes in the form of their alkaline (sodium and potassium in particular) salts, and the pro-fragrance compounds c) used were prepared by the methods generally described in the prior art documents U.S. Pat. No. 7,723,286 and/or WO 2008/154765.

### SPECIFIC EMBODIMENTS OF THE INVENTION

### Example 1

### Preparation of a Liquid Fabric Softener Composition According to Invention

A liquid fabric-softener base, forming component a) of the composition, was prepared by mixing the following ingredients in a generally known manner

| Ingredients | Parts by weight |
|---|---|
| Stepantex ® VL90 diester quat¹⁾ | 12.0 |
| Calcium Chloride | 0.2 |
| Deionised Water | 87.8 |
| Total | 100.0 |

¹⁾fabric softening ingredient; origin: Stepan Europe, France

The following samples were prepared by thoroughly admixing into the above softener base, in the concentrations indicated here-below (all weight % s being relative to the total weight of the final composition) a variety of components b) to d), as indicated below:

sample 1.1

1.8% of perfume component d), and 0.04% by weight of a 20% by weight solution in DIPG (dipropyleneglycol) of 1,2-benzisothiazol-3(2H)-one (sulfur-containing component b)).

Sample 1.2

1.8 weight % of perfume component d) and 0.036 weight % of 3-(dodecylthio)-1-(2,6,6-trimethyl-3-cyclohexen-1-yl)-1-butanone (pro-fragrance component c)).

Sample 1.3

1.8% of perfume component d), 0.04% of 1,2-benzisothiazol-3(2H)-one (20% solution in DIPG; component b)) and 0.036% of 3-(dodecylthio)-1-(2,6,6-trimethyl-3-cyclohexen-1-yl)-1-butanone as component c).

The above samples were subjected to two different tests.

Storage Test:

Samples 1.1, respectively 1.2 or 1.3, were stored in bottles for up to 90 days at 3°, 22°, 37° and 43° C. The samples stored at 22°, 37° and 43° C. were evaluated by comparison with the sample stored at 3° C., after 30 and 90 days, and their odour out of the bottle evaluated by a panel of evaluators, on blind tests, and rated according to a 1 to 5 point scale, as follows: 1=no change; 2=slight odour change; 3=odour changed, acceptable; 4=strong odour change, slight off odour perceived, not acceptable; 5=very strong odour change, strong off odour not acceptable (all changes relative to the sample stored at 3° C.).

Wash Test:

35 g of samples 1.1, respectively 1.2 or 1.3, were added into the fabric softener compartment of a Miele® washing machine type W300-CH33. The machine was loaded with 2 kg of standard cotton terry towels (50 towels of 25×25 cm, about 40 g each). The washing machine was launched using a 40° C. short cycle program. The washed towels were line dried for 24 h, then loosely packed into aluminium foil and stored. The towels were evaluated at 3 and 7 days after being washed (same panel and blind conditions as per the storage test) and the intensity of the odour perceived from the fabrics rated using the following 7 point scale: 1=no odour, 2=weak odour, 3=slightly weak odour, 4=medium odour, 5=slightly strong odour, 6=strong odour, 7=very strong odour.

In a second experience, using a different perfume as component d), similar tests were carried out with samples 2.1 to 4.2 below, prepared by admixing to the softener base the compounds indicated below, in the cited concentrations.

Sample 2.1

1.8 weight % of perfume component d) and 0.04% of 1,2-benzisothiazol-3(2H)-one (20% solution in DIPG; component b)).

Sample 2.2

1.8 weight % of perfume component d) and 0.036 weight % of 3-(dodecylthio)-1-(2,6,6-trimethyl-3-cyclohexen-1-yl)-3-butanone as component c).

Sample 2.3

1.8 weight % of perfume component d), 0.04 weight % of 1,2-benzisothiazol-3(2H)-one (20% solution in DIPG; component b)), and 0.036 weight % of 4-(dodecylthio)-4-(2,6,6-trimethylcyclohex-2-en-1-yl)-2-butanone as component c).

Sample 3.1

1.8 weight % of perfume component d) and 0.072 weight % of 4-(dodecylthio)-4-(2,6,6-trimethylcyclohex-2-en-1-yl)-2-butanone as component c).

Sample 3.2

1.8 weight % of perfume component d), 0.04 weight % of 1,2-benzisothiazol-3(2H)-one (20% solution in DIPG; component b)), and 0.072 weight % of 3-(dodecylthio)-1-(2,6,6-trimethyl-3-cyclohexen-1-yl)-3-butanone as component c).

Sample 4.1

1.8 weight % of perfume component d) and 0.048 weight % of methyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate as component c).

Methyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate was prepared as described in WO 2008/154765 and obtained as a mixture of diastereoisomers. High Resolution-MS (multimode, pos.): calculated for C₃₀H₅₀NO₄S [M+H]⁺ 520.3455 and C₃₀H₄₉NO₄SNa [M+Na]⁺ 542.3275. found 520.3457 and 542.3257.

Sample 4.2

1.8 weight % of perfume component d), 0.04 weight % of 1,2-benzisothiazol-3(2H)-one (20% solution in DIPG; component b)), and 0.048 weight % of methyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate as component c).

The results of all the evaluations thus carried out are shown in Table 1.

TABLE 1

| | Odour | | | | | | | |
|---|---|---|---|---|---|---|---|---|
| | Intensity on | | Odour Quality out of Bottle | | | | | |
| | Dry Fabric | | 30 days | | | 90 days | | |
| Sample No | 3 days | 7 days | 22° C. | 37° C. | 43° C. | 22° C. | 37° C. | 43° C. |
| 1.1 | 3.5 | 3.2 | 1 | 3 | 3 | 2 | 3 | 3 |
| 1.2 | 4.5 | 4.4 | 3 | 4 | 4 | 4 | 4 | 5 |
| 1.3 | 4.5 | 4.4 | 1 | 2 | 2 | 2 | 3 | 3 |
| 2.1 | 2.5 | 3.4 | 1 | 2 | 3 | 2 | 3 | 3 |
| 2.2 | 3.5 | 5.4 | 3 | 3 | 4 | 3 | 5 | 5 |
| 2.3 | 3.5 | 5.4 | 1 | 2 | 3 | 2 | 3 | 3 |
| 3.1 | 4.2 | 5.9 | 3 | 3 | 4 | 3 | 5 | 5 |
| 3.2 | 4.1 | 5.4 | 1 | 2 | 3 | 2 | 3 | 3 |
| 4.1 | 4.5 | 3.9 | 3 | 4 | 5 | 2 | 5 | 5 |
| 4.2 | 4.4 | 4.2 | 1 | 2 | 3 | 2 | 3 | 3 |

Comparison of samples 1.1. to 1.3 shows the effect of the different pro-fragrance components on the perceived odour intensity from fabric as well as the odour quality of the stored samples. While sample 1.1 showed a low odour intensity from fabric and an acceptable odour quality of the stored sample, samples 1.2 and 1.3 showed higher odour intensity from the fabric, but only sample 1.3 has according to the invention presented an acceptable odour quality after storage.

These results were confirmed when using a different perfume composition and different profragrance molecules in samples 2.1 to 4.2. Again only the samples according to the present invention samples 2.3, 3.2 and 4.2 show a high odour intensity on dry cloth and have an acceptable odour quality after storage.

1. A liquid composition, comprising:
a) a liquid base intended for the treatment of surfaces;
b) at least one sulfur-containing compound of formula 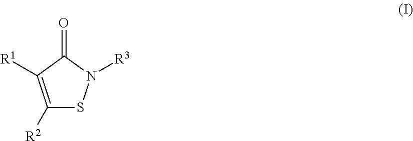
wherein R¹ and R² represent, separately and independently of each other, a hydrogen atom, a halogen atom, a C₁-C₄ linear or branched alkyl group, an amino group or a benzylamino group; or, alternatively, R¹ and R² are taken together to represent a phenyl or pyridine ring, possibly substituted with one to four C₁-C₄ linear or branched alkyl or alkenyl groups and/or one to two halogen atoms; and
R³ represents a hydrogen atom, an alkali metal atom, a phenyl or benzyl group possibly substituted with one or two halogen atoms and/or one or two methyl, trifluoromethyl, methoxy or amino groups, an amine group, or a C₁-C₈ unsaturated, linear, branched or cyclic hydrocarbon group possibly substituted with one or two nitrogen, oxygen or halogen atoms;
c) at least one sulfur-containing pro-fragrance compound; and
d) one or more perfuming co-ingredients;
and wherein the composition has a pH comprised between 1 and 8.

2. The composition according to claim 1, wherein such composition consists of a mixture of components a) to d).

3. The composition according to claim 1, wherein said component a) is a liquid softener base or an all-purpose cleaner base.

4. The composition according to claim 1, wherein the pH is below 6.

5. The composition according to claim 1, wherein said component a) represents at least 90% by weight, of the total weight of the composition.

6. The composition according to claim 1, comprising a component b) of formula (I) wherein R¹ and R² represent, separately and independently of each other, a hydrogen atom, a chlorine atom or a methyl group or, alternatively, R¹ and R² are taken together to represent a phenyl ring, and R³ represents a hydrogen atom or a methyl group.

7. The composition according to claim 1, wherein said component b) is selected from the group of isothiazolones consisting of 1,2-benzisothiazol-3(2H)-one, 4- or 5-chloro-2-methylisothiazol-3(2H)-one and 2-methylisothiazol-3(2H)-one, and is preferably 1,2-benzisothiazol-3 (2H)-one.

8. The composition according to claim 1, wherein aid component b) is present at a concentration comprised between 0.0001% weight and 5% weight, of the total weight of the composition.

9. The composition according to claim 8, wherein said component b) is present in a concentration comprised between 0.001 and 3 weight % relative to the total weight of the composition.

10. The composition according to claim 1, wherein said component c) is at least one compound of formula
Y—S-G-Q (II)
in which:
Y represents a radical selected amongst the group of radicals (Y-1) to (Y-7) shown here below, in any one of their possible isomeric forms, the wavy lines representing the location of the Y—S bond and the dotted lines representing the location of a single or double bond 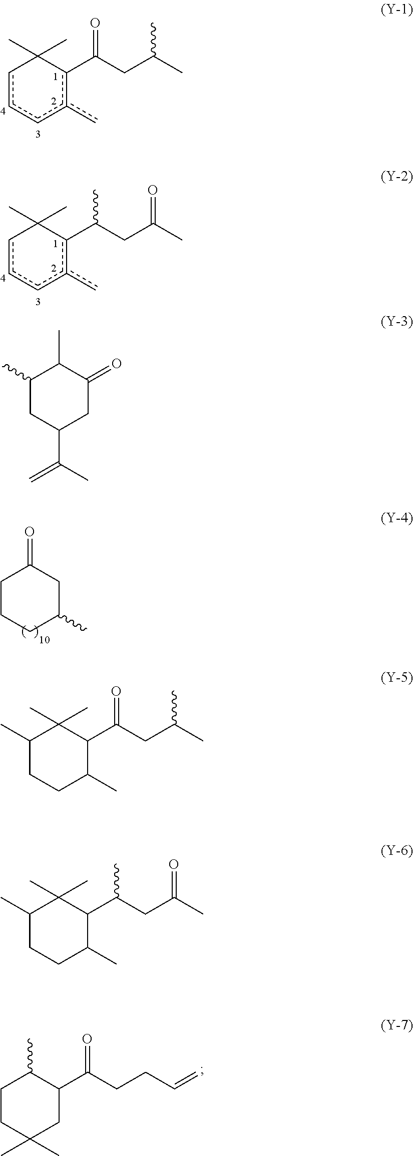
G represents a divalent or trivalent radical derived from a linear or branched alkyl or alkenyl radical having from 2 to 15 carbon atoms, possibly substituted with one or more groups selected from the group consisting of —OR⁴, —NR⁴₂, —COOR⁴ and R⁴ groups, in which R⁴ represents a hydrogen atom or a C₁ to C₆ alkyl or alkenyl group; and
Q represents a hydrogen atom, a —S—Y group or a NR⁵—Y group, Y being defined as above and R⁵ representing a hydrogen atom or a methyl group.

11. The composition according to claim 10, wherein said component c) is a compound of formula (II) wherein G is a divalent radical derived from a linear or branched alkyl or alkenyl radical having from 2 to 15 carbon atoms, possibly substituted with a —COOR⁴ group.

12. The composition according to claim 11, wherein said component c) is a compound of formula (II) wherein G is a divalent radical derived from a linear alkyl radical having from 8 to 15 carbon atoms, or a —CH₂CH(COOR⁴) group wherein R⁴ is a hydrogen atom, a methyl group or an ethyl group.

13. The composition according to claim 1, wherein said component c) is a compound of formula (II) wherein Y is any one of the Y-1, Y-2 or Y-3 groups as defined in claim 10.

14. The composition according to claim 1, wherein said pro-fragrance component is selected from the group consisting of methyl or ethyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate, methyl or ethyl 2-(4-oxo-4-(2,6,6-trimethylcyclohex-2-en-1-yl)butan-2-ylamino)-3-(4-oxo-4-(2,6,6-trimethylcyclohex-2-en-1-yl)butan-2-ylthio)propanate, methyl or ethyl 2-(2-oxo-4-(2,6,6-trimethylcyclohex-1-en-1-yl)butan-4-ylamino)-3-(2-oxo-4-(2,6,6-trimethylcyclohex-1-en-1-yl)butan-4-ylthio)propanate, methyl or ethyl 2-(2-oxo-4-(2,6,6-trimethylcyclohex-2-en-1-yl)butan-4-ylamino)-3-(2-oxo-4-(2,6,6-trimethylcyclohex-2-en-1-yl)butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-do decylsulfanyl-5-methyl-heptan-4-one, 2-cyclohexyl-1-do decylsulfanyl-hept-6-en-3-one and 3-(dodecylthio)-5-isopropenyl-2-methylcyclohexanone.

15. The composition according to claim 14, wherein said pro-fragrance component is selected from the group consisting of 3-(dodecylthio)-1-(2,6,6-trimethylcyclohex-3-en-1-yl)-1-butanone, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone and 3-(dodecylthio)-5-isopropenyl-2-methylcyclohexanone, and is preferably 3-(dodecylthio)-1-(2,6,6-trimethylcyclohex-3-en-1-yl)-1-butanone.

16. (canceled)

17. The composition according to claim 1, wherein said component d) is present in a concentration comprised between 0.01 weight %, and 3% weight, relative to the total weight of the composition.

18. A method for washing and/or softening of surfaces wherein the latter are treated, in a generally known manner, with a composition according to claim 1.
